(19) United States
(12) Patent Application Publication
(10) Pub. No.: US 2005/0190490 A1
(43) Pub. Date: Sep. 1, 2005

(54) Magnetic disc apparatus and manufacturing method of the same

(75) Inventors: Hitoshi Naruse, Tokyo (JP); Shigeki Yanagihara, Tokorozawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/988,972

(22) Filed: Nov. 16, 2004

(30) Foreign Application Priority Data
Feb. 26, 2004 (JP) 2004-052363

(51) Int. Cl. G11B 33/14

(52) U.S. Cl. 360/97.02

(57) ABSTRACT

Disclosed are a magnetic disc apparatus and a manufacturing method of the same. The magnetic disc apparatus including: a tray-shaped bottom container member having a first standing portion; a tray-shaped upper container member having a second standing portion, provided to face and contact the second standing portion with the first standing portion of the tray-shaped bottom container member; a functional component group including a disc clamper which is housed in an inside of a container formed by the tray-shaped bottom container member and the tray-shaped upper container member; and a seal member without seam provided on a circumferential outer wall surface of the container formed by the tray-shaped bottom container member and the tray-shaped upper container member, the circumferential outer wall surface including at least a region facing a contacting portion of the first standing portion and the second standing portion.

### CROSS-REFERENCE TO THE INVENTION

This application is based upon and claims the benefit of priority from the prior Japanese Patent Application No. 2004-52363, filed on Feb. 26, 2004; the entire contents of which are incorporated herein by reference.

### BACKGROUND

1. Field of the Invention

The present invention relates to a magnetic disc apparatus having a structure in which a functional component group is housed to be integrated, and a manufacturing method of the same, particularly for a magnetic disc apparatus suitable for downsizing, and the manufacturing method of the same.

2. Description of the Related Art

According to a request for downsizing in a mobile device and so on, in recent years, the downsizing of a magnetic disc apparatus is also required. A magnetic disc apparatus is structured so as to prevent dust in the air from entering into the inner portion thereof, because dust is very bad for an operation environment of the disc, in general. For example, a method in which a contacting surface is provided where a base (tray-shaped bottom container member) and a top cover (tray-shaped upper container member) of a container of a device are contacting, and a seal member (gasket) is shut in the contacting surface to seal up the container is adopted (Patent Document 1). Besides, as another structure for a sealing, there is a method that an adhesive tape is attached on a circumferential outer wall surface facing a contacting portion of a base and a top cover, to cover the contacting portion (Patent Document 2). Incidentally, between inside and outside of an apparatus is aerated by spiracles having a filter, in general.
[Patent Document 1] Japanese Patent Laid-open Application No. 2002-124077
[Patent Document 2] Japanese Patent Laid-open Application No. Hei 7-65535 (FIG. 4, FIG. 9)

In the structure stated in the above Patent Document 1, the contacting surface of the base and the top cover is necessary to be secured to have enough space for providing the seal member, and it is not considered to be suitable for the further downsizing of an apparatus. Besides, in the structure stated in the above Patent Document 2, it is considered that there is a room for improvement in terms of increasing the productivity because it takes labor for attaching the adhesive tape.

### SUMMARY

The present invention was made in view of the above-described circumstances, and an object thereof is to provide a magnetic disc apparatus and a manufacturing method thereof capable for downsizing and increasing the productivity, in the magnetic disc apparatus and the manufacturing method thereof structured so that a functional component group is housed to be integrated.

A magnetic disc apparatus according to an aspect of the present invention, including: a tray-shaped bottom container member having a first standing portion; a tray-shaped upper container member having a second standing portion, provided to face and contact the second standing portion with the first standing portion of the tray-shaped bottom container member; a functional component group including a disc damper which is housed in an inside of a container formed by the tray-shaped bottom container member and the tray-shaped upper container member, and a seal member without seam provided on a circumferential outer wall surface of the container formed by the tray-shaped bottom container member and the tray-shaped upper container member, the circumferential outer wall surface including at least a region facing a contacting portion of the first standing portion and the second standing portion.

That is to say, in this magnetic disc apparatus, the seal member is provided on the circumferential outer wall surface of the container formed by the tray-shaped bottom container member and the tray-shaped upper container member, the circumferential outer wall surface includes at least the region facing the contacting portion of the first standing portion and the second standing portion, and the seal member is a member without seam. Accordingly, it is not necessary to secure the space on the contacting surface of the tray-shaped bottom container member and the tray-shaped upper container member enough to provide the seal member, and therefore, it is suitable for downsizing. Besides, the seal member is formed without seam, and can be formed in general, for example, by an injection molding of a resin, and therefore, it is suitable for improvement in productivity.

Besides, a manufacturing method of a magnetic disc apparatus according to an aspect of the present invention, including: assembling a functional component group in a tray-shaped bottom container member having a first standing portion; housing the functional component group in an inner portion by facing and confronting the first standing portion of the tray-shaped bottom container member in which the functional component group is assembled, with a second standing portion of a tray-shaped upper container member having the second standing portion, and by relatively fixing the tray-shaped bottom container member and the tray-shaped upper container member; settling a container formed by the tray-shaped bottom container member which houses the functional component group therein and the tray-shaped upper container member, into a mold which has a larger volume capacity than a whole volume of the container formed by the tray-shaped bottom container member and the tray-shaped upper container member, the mold having a space at least towards a circumferential outer wall surface of the settled container formed by the tray-shaped bottom container member and the tray-shaped upper container member, the circumferential outer wall surface facing to a contacting portion of the first standing portion and the second standing portion; and forming a molded resin portion in the space between the mold and the settled container by injecting a resin into the mold.

Further, a manufacturing method of a magnetic disc apparatus according to another aspect of the present invention, including: assembling a functional component group in a tray-shaped bottom container member having a first standing portion; housing the functional component group in an inner portion by facing and confronting the first standing portion of the tray-shaped bottom container member in which the functional component group is assembled, with a second standing portion of a tray-shaped upper container member having the second standing portion, and by relatively fixing the tray-shaped bottom container member and the tray-shaped upper container member; and injecting a resin by using a dispenser to cover a region which is a circumferential outer wall surface of a container formed by the tray-shaped bottom container member and the tray-shaped upper container member, and faces to a contacting portion of the first standing portion and the second standing portion.

These manufacturing methods are the respective methods to manufacture the above stated magnetic disc apparatus, and the seal member is composed of a molded resin portion by injecting a resin, or formed by using a dispenser.

According to the present invention, downsizing and improvement in productivity are possible in the magnetic disc apparatus and the manufacturing method of the same in which the functional component group is housed to be integrated.

### BRIEF DESCRIPTION OF THE DRAWINGS

FIG. 1A, FIG. 1B, and FIG. 1C are schematic perspective views showing a magnetic disc apparatus according to an embodiment of the present invention in accordance with a manufacturing process thereof.

FIG. 2A and FIG. 2B are continuous views of FIG. 1C, and are schematic perspective views showing the magnetic disc apparatus according to the embodiment of the present invention in accordance with the manufacturing process thereof.

FIG. 3 is a schematic perspective view showing an external appearance of the magnetic disc apparatus according to the embodiment of the present invention.

FIG. 4A is a schematic perspective view showing an external appearance of a magnetic disc apparatus, and FIG. 4B is a partial sectional view showing the magnetic disc apparatus according to another embodiment of the present invention.

FIG. 5A, FIG. 5B, and FIG. 5C are partial sectional views respectively showing a magnetic disc apparatus according to still another embodiment of the present invention.

FIG. 6 is a schematic perspective view showing an external appearance of a magnetic disc apparatus according to yet another embodiment of the present invention.

FIG. 7A is a schematic perspective view showing an external appearance of a magnetic disc apparatus, and FIG. 7B is a sectional view of the magnetic disc apparatus according to yet another embodiment of the present invention.

FIG. 8A and FIG. 8B are views respectively showing examples of vibration conditions on an outer surface of a magnetic disc apparatus measured by a laser Doppler vibration meter.

### DETAILED DESCRIPTION

### Explanation of Embodiments

Embodiments of the present invention will be described with reference to the drawings, but these drawings are provided only for illustrative purposes and by no means are intended to limit the present invention.

As a form of an embodiment of the present invention, the circumferential outer wall surface of the container formed by the tray-shaped bottom container member and the tray-shaped upper container member has a hollow, and the seal member without seam may be provided in an inner portion of the hollow so as not to be projected from the hollow. By providing the seal member in the inner portion of the hollow, the occurrence of failure such that the seal member is peeled off caused by a handling can be reduced.

As another form, the tray-shaped bottom container member and the tray-shaped upper container member are approximately rectangles as a tray shape, and have shapes such that edge line portions and vertex portions which are outside of the container and corresponding to vertexes of the rectangles; are disappeared. The seal member without seam may be provided to come to on an outer surface being formed by the disappeared edge line portions of the tray-shaped bottom container member and the tray-shaped upper container member, and the seal member without seam forms renewed edge line portions and vertex portions instead of the disappeared edge line portions and vertex portions of the tray-shaped bottom container member and the tray-shaped upper container member. The seal member forms the renewed edge line portions and vertex portions, and thereby the portions become buffer portions. Accordingly, it is possible to make a magnetic disc apparatus rare to have a mechanical shock by, for example, a handling, furthermore. Consequently, the occurrence of failure can further be reduced.

Further, as still another form, the seal member without seam may be formed at least to come to both sides of outer upper and lower surfaces of the container formed by the tray-shaped bottom container member and the tray-shaped upper container member in the longitudinal direction of the circumferential outer wall surface. By forming the seal member to come to the both sides of the outer upper and lower surfaces, the corners made by the both sides of the outer upper and lower surfaces are covered with the seal member to be buffer portions, and thereby the form can be made rare to have a mechanical shock.

Here, the tray-shaped bottom container member may have a slope at a region which is an outside of the container and is surrounded by the first standing portion, and the seal member without seam may be provided to come to on the slope of the tray-shaped bottom container member, and forms edge line portions alternatively which are disappeared because the tray-shaped bottom container member has the slope. Besides, the tray-shaped upper container member may have a slope at a region which is an outside of the container and is surrounded by the second standing portion, and the seal member without seam may be provided to come to on the slope of the tray-shaped upper container member, and it forms edge line portions alternatively which are disappeared because the tray-shaped upper container member has the slope. In both cases, the slopes are formed and the seal members are provided thereon, so the thickness of the seal member at these regions becomes thicker. Accordingly, as a buffer portion it is possible to make the shape rare to have a mechanical shock, furthermore.

Further, as yet another form, the tray-shaped bottom container member may have the hollow on an outer bottom surface of the container, and the seal member without seam is provided to come to an inner portion of the hollow on the outer bottom surface of the tray-shaped bottom container member. Besides, the tray-shaped upper container member may have a hollow on an outer upper surface of the container, and the seal member without seam is provided to come to an inner portion of the hollow on the outer upper surface of the tray-shaped upper container member. In both cases, the seal members are also utilized as vibration suppression members. Consequently, a generated noise level can be reduced.

Here, the hollow on the outer upper surface of the tray-shaped upper container member may be provided avoiding a region of the tray-shaped upper container member which positions directly above the disc clamper. It is to dispose a projecting portion toward the inner portion of a magnetic disc formed when the hollow is provided on the outer upper surface of the tray-shaped upper container member, other than the position directly above the disc clamper. The thickness of the portion where the disc damper is disposed is one of the thickest portions, and therefore this portion is avoided. Consequently, the device becomes suitable for downsizing.

Besides, here, the hollow on the outer upper surface of the tray-shaped upper container member may be provided including the most mechanically bendable region of the tray-shaped upper container member. The hollow is formed at the most mechanically bendable portion and the vibration suppression member composed of the seal member is provided, then the more effective vibration suppression becomes possible.

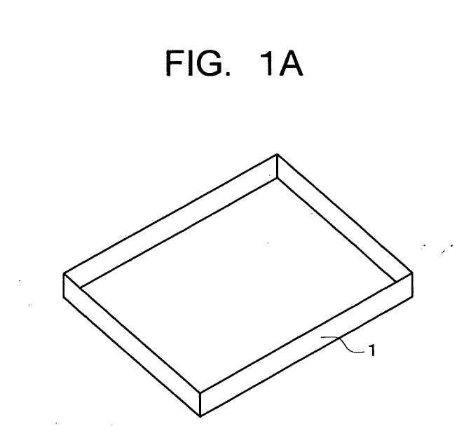

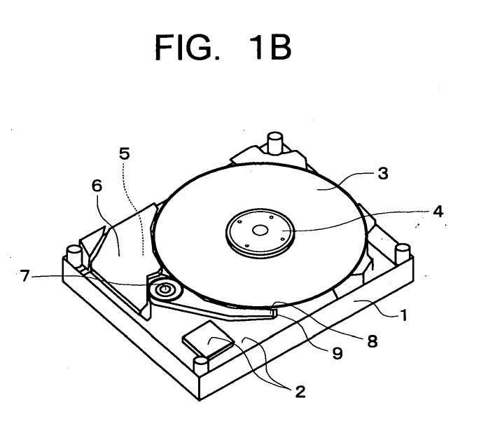

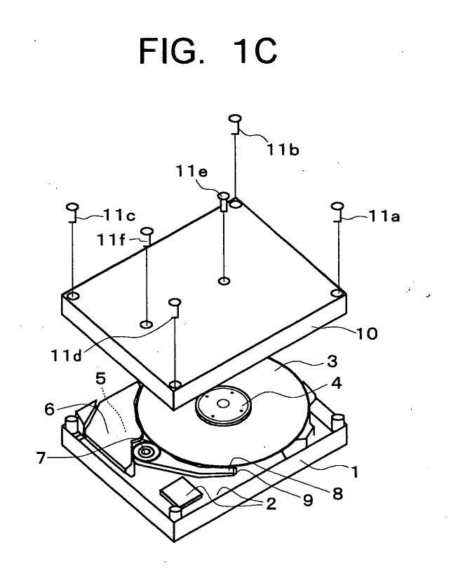

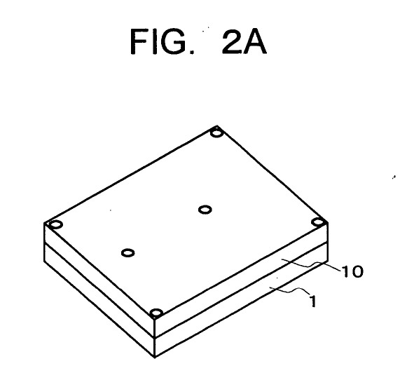

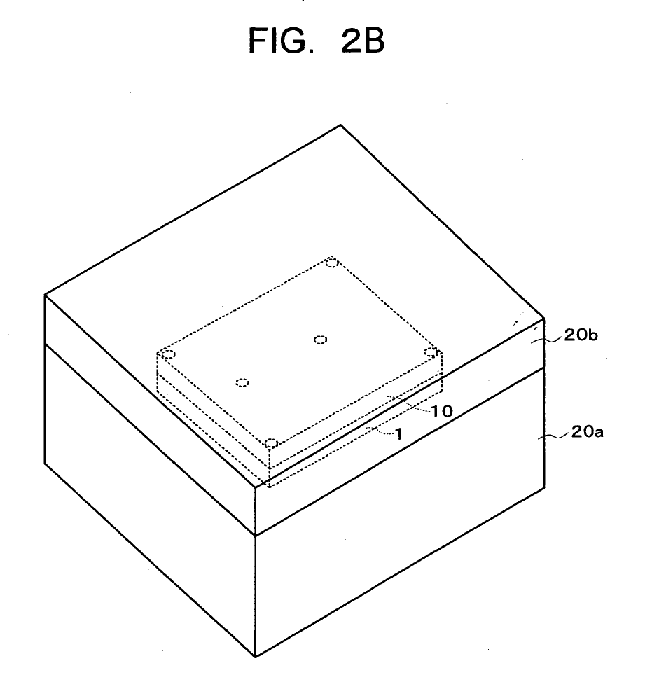

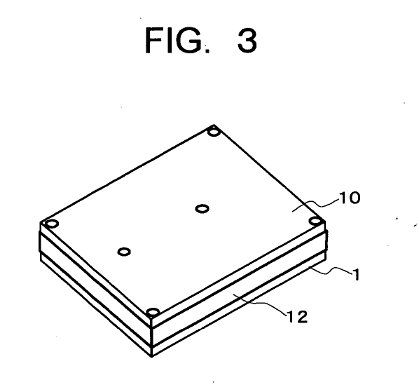

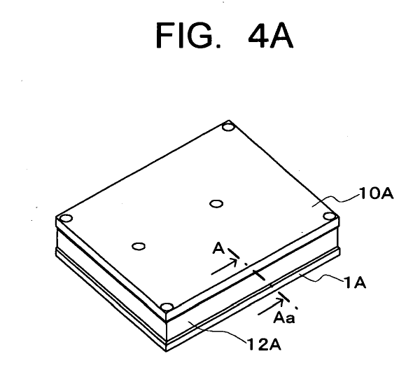

Building on the above, embodiments of the present invention will be described hereinafter with reference to the drawings. FIG. 1A, FIG. 1B, and FIG. 1C are schematic perspective views showing a magnetic disc apparatus according to an embodiment of the present invention in accordance with manufacturing process thereof. FIG. 2A and FIG. 2B are continuous views of FIG. 1C, and are schematic perspective views showing the magnetic disc apparatus of the embodiment of the present invention in accordance with the manufacturing process thereof. FIG. 3 is a schematic perspective view showing an external appearance of the magnetic disc apparatus according to the embodiment of the present invention. The process progresses in the order of FIG. 1A, FIG. 1B, FIG. 1C, FIG. 2A, FIG. 2B, and FIG. 3. Hereinafter, the process will be explained in the order of events.

First, a base 1 being a tray-shaped bottom container member as shown in FIG. 1A is prepared. As a material thereof, it is composed of, for example, metal (alloy) with stiffness. As shown in the drawing, it has a lower surface member in a rectangle shape, and a standing portion continuously provided in circumference, standing from an end portion of this lower surface member. A press forming or a die casting, for example, can be used to form metal into such a shape. An upper end portion of the standing portion may be extremely thin. By making the upper end portion thin, it becomes suitable for downsizing of a magnetic disc apparatus. Incidentally, a region for assembling and fixing a functional component group within this (inside of the tray shape), spiracles, and so on are not shown in the drawing.

Next, as shown in FIG. 1B, the respective functional components are assembled in the base 1. Main components thereof are, for example, a substrate unit 2, a spindle motor (not shown), a magnetic disc 3, a disc damper 4, a voice coil motor 5 containing a top yoke 6 and a bottom yoke (not shown), a pivot 7, a slider 8, a magnetic head 9, and so on.

The substrate unit 2 functions as an electrical processing section of this apparatus. The magnetic disc 3 is a recording medium, and a base material thereof is, for example, a glass or aluminum. The magnetic disc 3 is fixedly supported by the disc damper 4 in a rotatable manner, and it can be rotated by the spindle motor. The voice coil motor 5 is a motor to move the magnetic head 9 provided at a tip portion of the slider 8, in a radial direction of the magnetic disc 3 by using the pivot 7 as a fulcrum, and it contains the top yoke 6 and the bottom yoke. As these structures in themselves, publicly known ones can be used. The functional component group generally contains every necessary components as a magnetic disc apparatus.

Next, as shown in FIG. 1C, a top cover 10 being a tray-shaped upper container member is prepared, and the functional component group is housed in a container (it is also called as a disc enclosure) formed by the base 1 and the top cover 10. More specifically, as a shape of the top cover 10, the shape having the same standing portion as that of the base 1 is used, and four corners and so on, of the rectangle are attached by screws 11a to 11f to fix it to the base 1 side. Fixing regions of the screws are provided at each center of the disc damper 4 and the pivot 7 in addition to the four corners as shown in the drawing. Consequently, they can be firmly fixed. The respective standing portions of the base 1 and the top cover 10 are confronted with facing the end portions thereof. Incidentally, a material and a forming method of the top cover 10 are the same as those of the base 1. A combined device as shown in FIG. 2A can be obtained by fixing the screws 11a to 11f. The screws 11e, 11f (screws provided for the respective centers of the disc damper 4 and the pivot 7) are not necessarily required depending on a structure of a functional component group.

On a circumferential outer wall surface of the combined device shown in FIG. 2A, there is a contacting portion formed by the respective standing portions of the base 1 and the top cover 10 facing each other. This contacting portion is just a mechanical contact of members and it is not airtight when examined in detail. A process to attach a seal member thereon for sealing off the region and inhibiting the entering of dust is performed hereinafter.

As shown in FIG. 2B, a mold composed of a lower mold 20a and an upper mold 20b is prepared. In the inside of this mold, there is a volume capacity enough to settle the combined device shown in FIG. 2A, and there is a space to form a seal member on a region which is a circumferential outer wall surface of the combined device and which is facing the contacting surface of the standing portion of the base 1 and the standing portion of the top cover 10. The combined device shown in FIG. 2A is settled in the inside of the mold, and a resin is injected into the above-mentioned space. Consequently, a seal member without seam composed of a molded resin portion is made to cover the contacting portion formed by the respective standing portions of the base 1 and the top cover 10 facing each other.

The shape of the formed seal member becomes such as a seal member 12 shown in FIG. 3. Consequently, the contacting portion of the base 1 and the top cover 10 becomes airtight. This magnetic disc apparatus does not provide the space for disposing the seal member 12 in an inner portion of a contacting surface (facing surface) of the base 1 and the top cover 10, and therefore it is suitable for downsizing of the device as a whole. Such a downsizing becomes more important from its relative size relation when the magnetic disc 3 smaller than 1 inch radial is to be used. Besides, the seal member 12 can be formed integrally without seam by the injection molding of a resin, and therefore the productivity becomes high and the reliability is also good. Incidentally, it is preferable that a resin forming the seal member 12 has a small outgas, a high adhesiveness with metal, a low-hardness, and a good moldability. For example, HDD cover seal adhesive: TB3089 manufactured by TreeBond can be used.

In addition to the method forming the seal member 12 by using the mold, it is possible to use a method to inject a resin by using a dispenser on the circumferential outer wall surface to cover the contacting portion of the base 1 and the top cover 10. In the method, a mold is not used, and therefore, it is suitable for manufacturing a small amount at a low cost.

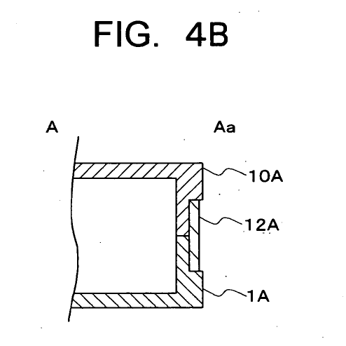

Next, another embodiment of the present invention will be explained with reference to FIG. 4A and FIG. 4B. FIG. 4A is a schematic perspective view showing an external appearance of a magnetic disc apparatus, and FIG. 4B is a partial sectional view of the magnetic disc apparatus according to another embodiment of the present invention. FIG. 4B is a sectional view taken along the line A-Aa shown by the arrows in FIG. 4A.

The magnetic disc apparatus according to this embodiment can also be manufactured by the same process as the above described embodiment. The difference is, a base 1A instead of the base 1, and a top cover 10A instead of the top cover 10 are prepared. Namely, a shape thereof is that a vicinity of end portions of both standing portions go backward into a container so that a continuous hollow is to be provided on a circumferential outer wall surface of the container.

Then, a seal member 12A is formed to fit in an inner portion of the hollow on the circumferential outer wall surface of the container formed by the base 1A and the top cover 10A. According to such a form, the seal member 12A is not projected from the circumferential outer wall surface, and therefore the occurrence of failure such that the formed seal member 12A is peeled off, for example, by a handling can be efficiently reduced.

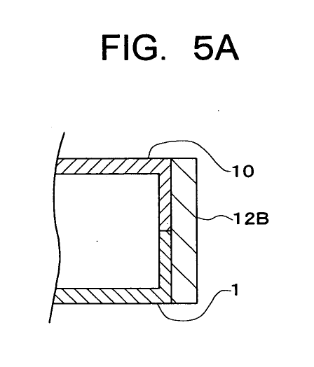

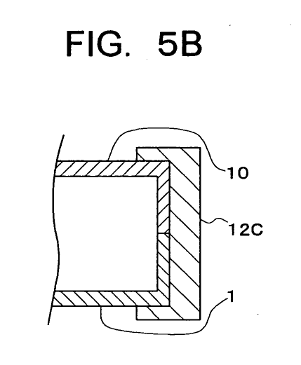

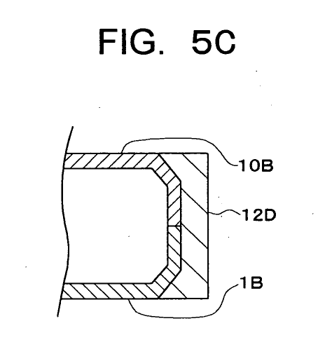

Next, a magnetic disc apparatus according to still another embodiment of the present invention will be explained with reference to FIG. 5A, FIG. 5B, and FIG. 5C. FIG. 5A, FIG. 5B, and FIG. 5C are partial sectional views respectively showing a magnetic disc apparatus according to still another embodiment of the present invention. Three examples of FIG. 5A, FIG. 5B, and FIG. 5C are shown, and the respective cross sections of those are corresponding to the position of the cross section A-Aa shown in FIG. 4A. In FIG. 5A, FIG. 5B, and FIG. 5C, the same reference numerals and symbols are used to designate the same and corresponding elements already described.

In the mode shown in FIG. 5A, the formation of a seal member 12B is made to come to both sides of outer upper and lower surfaces (outer upper surface and outer lower surface) of a disc enclosure. Such a formation of the seal member 12B can be made, for example, by an injection molding using a mold as well as the cases in the above-described respective embodiments.

In such a mode, corners (edge line portion) formed by the both sides of the outer upper and lower surfaces and a circumferential outer wall surface of the disc enclosure are further protected by the seal member 12B. The seal member 12B is composed of a resin, and it has at least a larger buffering action than metal. Accordingly, corners which are easy to have a mechanical shock are protected, and as a whole, the device becomes to have a resistance for the mechanical shock, for example, at the time of falling and so on.

The effect of a mode shown in FIG. 5A is similarly exhibited in the case when the formation of a seal member 12C further comes to on the both sides of the outer upper and lower surfaces of the disc enclosure as shown in FIG. 5B. Besides, as shown in FIG. 5C, in the case when the respective portions surrounded by both standing portions of a base 1B and a top cover 10B have slopes, and a seal member 12D is made to form corners (edge line portion) of the whole apparatus, the effect is exhibited similarly.

Incidentally, FIG. 5A, FIG. 5B, and FIG. 5C are symmetric in longitudinal direction of the respective cross-sectional shapes. However, the embodiment in which any base and any top cover within the drawings are selected and the cross-sectional shapes thereof become asymmetric in longitudinal direction can also be adopted.

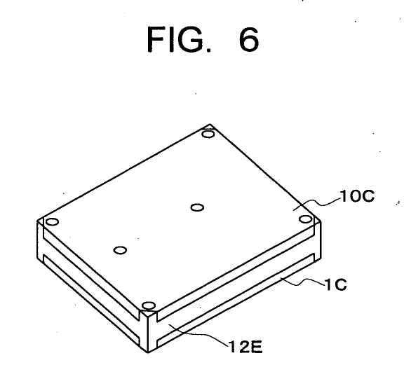

Next, a magnetic disc apparatus according to yet another embodiment of the present invention will be explained with reference to FIG. 6. FIG. 6 is a schematic perspective view showing an external appearance of a magnetic disc apparatus according to yet another embodiment of the present invention.

The magnetic disc apparatus according to this embodiment can also be manufactured by the same process as the above described respective embodiments. The difference is that the apparatus has a shape that four corners of a disc enclosure go backward such as a base 1C and a top cover 10C relative to the embodiment shown in FIG. 3, and a seal member 12E forms edge line portions and vertex portions alternatively which are disappeared because the four corners go backward.

An effect of this embodiment is in common with those of the respective forms in FIG. 5A, FIG. 5B, and FIG. 5C, in which the resistance for a mechanical shock is strengthened. However, in the present embodiment, the seal member 12E exists at both the vertex portions and the edge line portions where a shock is particularly often to occur, as a buffering member, and therefore it becomes a more efficient arrangement.

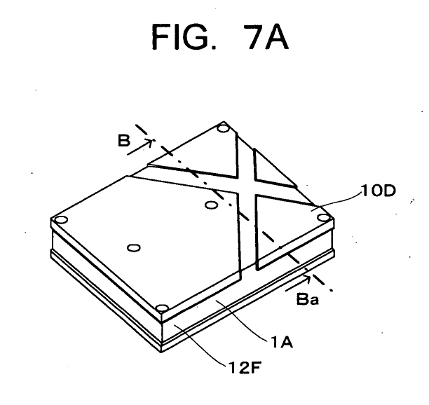

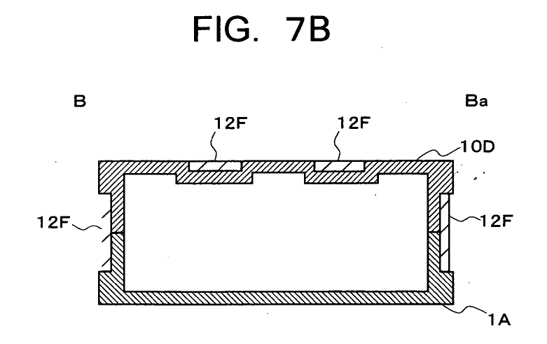

Next, a magnetic disc apparatus according to yet another embodiment of the present invention will be explained with reference to FIG. 7A and FIG. 7B. FIG. 7A is a schematic perspective view showing an external appearance of the magnetic disc apparatus, and FIG. 7B is a sectional view of the magnetic disc apparatus according to yet another embodiment of the present invention. FIG. 7B is a sectional view taken along the line B-Ba shown by the arrows in FIG. 7A (note that the functional component group housed inside is not shown in the drawings).

In this embodiment, a seal member 12F formed without seam is further used as a vibration suppression member. The magnetic disc apparatus according to this embodiment can also be manufactured by the same process as the above-described respective embodiments. As shown in FIG. 7A and FIG. 7B, the seal member 12F not only covers a contacting portion of a base 1A and a top cover 10D, but also is further integrally formed in an inner portion of a hollow provided on an outer upper surface of the top cover 10D. In this embodiment, a hollow is newly provided on the outer upper surface of the top cover 10D, but of course, it is also available that a new hollow is provided on an outer bottom surface of the base 1A, and the seal member 12F is integrally formed in an inner portion of the hollow.

According to such an embodiment, vibrations generated by bendings of the top cover 10D and the base 1A can be restrained. Consequently, noises can be dominantly reduced. An effect of vibration suppression is achieved because the top cover 10D and the base 1A being bending members are physically damped by the seal member 12F being the vibration suppression member. Therefore, it is preferable that allocations of the seal members 12F on the top cover 10D and on the base 1A are to be provided including the most bendable portions of these members. On this account, in the cases as shown in FIG. 7A and FIG. 7B, the seal member 12F is selected to be allocated at a region where it is directly above the magnetic disc 3 and departed from the respective screws to fix the top cover 10D.

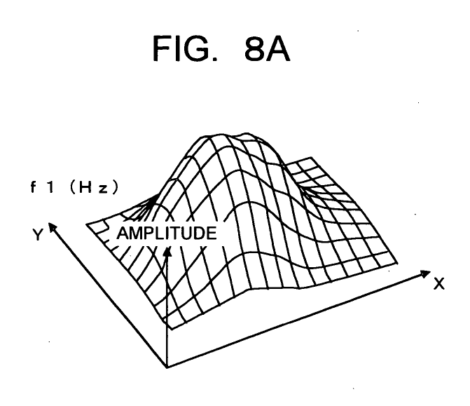

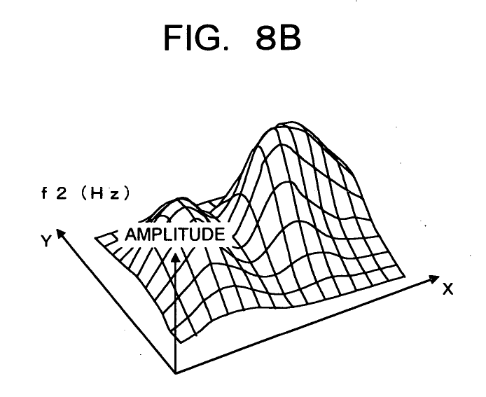

More specifically, such a selection of positioning can be performed by using measured results by a laser Doppler vibration meter as shown in FIG. 8A and FIG. 8B. FIG. 8A and FIG. 8B are views showing examples of vibration conditions on an outer surface of a magnetic disc apparatus measured by the laser Doppler vibration meter. FIG. 8A and FIG. 8B show components of certain frequencies f1 and f2, respectively, and amplitudes are shown in the Z directions in the drawings. It is conceivable that, as generation factors of these vibrations, vibrations generated by a rotation of a spindle motor or a movement of a slider 8 are propagated in either solid or air. Portions having large vibrations can be specified by the measured results as shown in FIG. 8A and FIG. 8B. Therefore a large effect of noise reduction can be achieved by providing the hollow where the seal member 12F is positioned at the region including the portions.

It is advantageous for downsizing in the thickness direction that the hollow of the top cover 10D for providing the seal member 12F being acted as the vibration suppression member, are provided avoiding a portion directly above a disc clamper 4. As shown in FIG. 7B, considering the case when a projecting portion is formed in an inner surface of the top cover 10D caused by forming the hollow, the disc clamper 4 is disposed at a region avoiding the projecting portion. The portion where the disc clamper 4 is disposed is one of the thickest regions, and therefore, the thickness of the apparatus as a whole can be reduced by disposing the disc clamper 4 at the region which is not overlapped with the projecting portion.

As described above, according to the embodiments of the present invention, every inner parts composing a magnetic disc apparatus are mounted, then a top cover is fixed to a base by screwing or the like, and thereafter, a resin is formed by, for example, an injection molding so as to cover all the boundaries between the base and the top cover. Consequently, a sealing of an inside of a magnetic disc apparatus can be performed easily even in the case where it is very difficult to dispose a gasket keeping airtightness in an inside of an apparatus such as a microminiature magnetic disc apparatus having, for example, 1 inch or less in size. Accordingly, a magnetic disc apparatus which is compact but has high airtightness can be provided. Besides, the seal member is integrally molded on the surface of the top cover all at once, and thereby it is possible to damp vibrations of the top cover, then a low noise effect can also be obtained. Further, the seal member is provided at four corners, and so on, of the magnetic disc apparatus as impact buffering portions, and thereby the magnetic disc apparatus having a high buffering resistance can be provided.

The present invention is not limited to the specific embodiments described here with reference to the drawings, but it is understood that all changes which come within the range of the following claims are intended to be embraced therein.

1. A magnetic disc apparatus, comprising:
a tray-shaped bottom container member having a first standing portion;
a tray-shaped upper container member having a second standing portion, provided to face and contact the second standing portion with the first standing portion of the tray-shaped bottom container member;
a functional component group including a disc clamper which is housed in an inside of a container formed by the tray-shaped bottom container member and the tray-shaped upper container member; and
a seal member without seam provided on a circumferential outer wall surface of the container formed by the tray-shaped bottom container member and the tray-shaped upper container member, the circumferential outer wall surface including at least a region facing a contacting portion of the first standing portion and the second standing portion.

2. A magnetic disc apparatus as set forth in claim 1,
wherein the circumferential outer wall surface of the container formed by the tray-shaped bottom container member and the tray-shaped upper container member has a hollow, and
the seal member without seam is provided in an inner portion of the hollow so as not to be projected from the hollow.

3. A magnetic disc apparatus as set forth in claim 1,
wherein the tray-shaped bottom container member and the tray-shaped upper container member are approximately rectangles as a tray shape, and have shapes such that edge line portions and vertex portions which are an outside of the container and corresponding to vertexes of the rectangles are disappeared, and
the seal member without seam is provided to come to on an outer surface being formed by the disappeared edge line portions of the tray-shaped bottom container member and the tray-shaped upper container member, and forms renewed edge line portions and vertex portions instead of the disappeared edge line portions and vertex portions of the tray-shaped bottom container member and the tray-shaped upper container member.

4. A magnetic disc apparatus as set forth in claim 1,
wherein the seal member without seam is formed at least to come to both sides of outer upper and lower surfaces of the container formed by the tray-shaped bottom container member and the tray-shaped upper container member in longitudinal direction of the circumferential outer wall surface.

5. A magnetic disc apparatus as set forth in claim 4,
wherein the tray-shaped bottom container member has a slope at a region which is an outside of the container and is surrounded by the first standing portion, and
the seal member without seam is also provided to come to on the slope of the tray-shaped bottom container member, and forms edge line portions alternatively which are disappeared because the tray-shaped bottom container member has the slope.

6. A magnetic disc apparatus as set forth in claim 4,
wherein the tray-shaped upper container member has a slope at a region which is an outside of the container and is surrounded by the second standing portion, and
the seal member without seam is also provided to come to on the slope of the tray-shaped upper container member, and forms edge line portions alternatively which are disappeared because the tray-shaped upper container member has the slope.

7. A magnetic disc apparatus as set forth in claim 1,
wherein the tray-shaped bottom container member has a hollow on an outer bottom surface of the container, and
the seal member without seam is also provided to come to an inner portion of the hollow on the outer bottom surface of the tray-shaped bottom container member.

8. A magnetic disc apparatus as set forth in claim 1,
wherein the tray-shaped upper container member has a hollow on an outer upper surface of the container,
the seal member without seam is also provided to come to an inner portion of the hollow on the outer upper surface of the tray-shaped upper container member.

9. A magnetic disc apparatus as set forth in claim 8,
wherein the hollow on the outer upper surface of the tray-shaped upper container member is provided avoiding a region of the tray-shaped upper container member which positions directly above the disc clamper.

10. A magnetic disc apparatus as set forth in claim 8,
wherein the hollow on the outer upper surface of the tray-shaped upper container member is provided including most mechanically bendable region of the tray-shaped upper container member.

11. A manufacturing method of a magnetic disc apparatus, comprising:
assembling a functional component group in a tray-shaped bottom container member having a first standing portion;
housing the functional component group in an inner portion by facing and confronting the first standing portion of the tray-shaped bottom container member in which the functional component group is assembled, with a second standing portion of a tray-shaped upper container member having the second standing portion, and by relatively fixing the tray-shaped bottom container member and the tray-shaped upper container member;
settling a container formed by the tray-shaped bottom container member which houses the functional component group therein and the tray-shaped upper container member, into a mold which has a larger volume capacity than a whole volume of the container formed by the tray-shaped bottom container member and the tray-shaped upper container member, the mold having a space at least towards a circumferential outer wall surface of the settled container formed by the tray-shaped bottom container member and the tray-shaped upper container member, the circumferential outer wall surface facing to a contacting portion of the first standing portion and the second standing portion; and
forming a molded resin portion in the space between the mold and the settled container by injecting a resin into the mold.

12. A manufacturing method of a magnetic disc apparatus, comprising:
assembling a functional component group in a tray-shaped bottom container member having a first standing portion;
housing the functional component group in an inner portion by facing and confronting the first standing portion of the tray-shaped bottom container member in which the functional component group is assembled, with a second standing portion of a tray-shaped upper container member having the second standing portion, and by relatively fixing the tray-shaped bottom container member and the tray-shaped upper container member; and
injecting a resin by a dispenser to cover a region which is a circumferential outer wall surface of a container formed by the tray-shaped bottom container member and the tray-shaped upper container member, and faces to a contacting portion of the first standing portion and the second standing portion.
